(19) United States
(12) Patent Application Publication
(10) Pub. No.: US 2011/0013015 A1
(43) Pub. Date: Jan. 20, 2011

(54) VISION INSPECTION SYSTEM AND INSPECTION METHOD USING THE SAME

(75) Inventors: Heui Jae Park, Seoul (KR); Il Hwan Lee, Seoul (KR); Sung Bum Kang, Seoul (KR)

Correspondence Address: Echelon Law Group, PC, 1919 Gallows Road., Suite 330, Vienna, VA, 22182, US

(73) Assignee: SNU Precision co., Ltd, Seoul (KR)

(21) Appl. No.: 12/918,025

(22) PCT Filed: Feb. 10, 2009
(86) PCT No.: PCT/KR09/00602

§ 371 Date: Aug. 17, 2010

(30) Foreign Application Priority Data
Feb. 18, 2008 (KR) 10-2008-0014403

(51) Int. Cl. H04N 7/18

(52) U.S. Cl. 348/125; 348/137; 348/E07.085

(57) ABSTRACT

A vision inspection system for inspecting an inspection object of various types, and an inspection method of inspecting an inspection object using the vision inspection system are disclosed. The vision inspection system comprises a work-piece stage having a table on which an inspection object is placed, a plurality of linescan cameras, and a computer configured to process a scanned image of the inspection object. A plurality of markings, each of which has a marking stage coordinate value, are provided on an upper surface of the table such that the linescan cameras can obtain scanned images of the markings. Each two neighboring markings are placed in a field of view of each of the linescan cameras. The markings between the first and the last markings are respectively placed in such a way as to overlap within the fields of view of each two neighboring linescan cameras. The inspection method calculates a work-piece image-stage coordinate value using a marking image coordinate value and a work-piece image coordinate value, and determines the inspection object as being non-defective when the work-piece image-stage coordinate value falls within an allowable tolerance range with respect to the work-piece stage coordinate value.

### CROSS-REFERENCE TO RELATED APPLICATION(S)

This application claims the benefit under 35 U.S.C. §119(a) of International Patent Application No. PCT/KR2009/000602, filed on Feb. 10, 2009, the entire disclosure of which is incorporated herein by reference for all purposes.

### BACKGROUND

1. Field

The following description relates to a vision inspection system and a method of inspecting an inspection object using the same, and more particularly, to a vision inspection system which obtains a number of scanned images of an inspection object for inspection, and an inspection method of inspecting the inspection object using the vision inspection system.

2. Description of the Related Art

An optical inspection system consists of a camera and a computer. The camera obtains image data by capturing images of various inspection objects and the computer processes the image data input from the camera using an image processing program. The optical inspection system has been widely utilized in various fields including recognition and inspection of an inspection object, sorting out defective or non-defective work-pieces, and the like.

A number of patent applications such as U.S. Pat. No. 7,030,351 and US Patent Application No. 2003/0197925 A1 disclose a vision inspection system. Especially, the vision inspection system disclosed in the above mentioned documents consists of a work-piece stage, a camera stage, a controller, a camera, and a computer. The work-piece stage is movable along an X axis and a Y axis so as to load, unload, and position a work-piece. The camera stage is installed above the work-piece stage and is operable to move and rotate along the X, Y, and Z axes for positioning and focusing the camera. The controller is connected to the computer to control the operation of the work-piece stage, the camera stage, and the camera.

According to the prior art, the vision inspection system employs a linescan camera with a high resolution to precisely inspect a defect of the work-piece in micrometer units. The linescan camera scans an inspection object along one horizontal line to acquire a scanned image. The inspection of large-sized inspection objects including a cell, a panel, a module, and a glass substrate such as a thin film transistor-liquid crystal display (TFT-LCD), a plasma display panel (PDP), and an organic electroluminescence (OEL) is performed by a number of linescan cameras. The linescan cameras divide the entire inspection object into a plurality of areas and scan the divided areas. A plurality of markings are placed on scanned images as reference points such that coordinates of a defect can be calculated with reference to the markings by the computer that processes the scanned images.

However, the vision inspection system according to the prior art has the respective linescan cameras positioned by the individual camera stages, so that it takes a significant amount of time and effort for the arrangement of the linescan cameras, and precise alignment of the linescan cameras is difficult to achieve. The positions of the linescan cameras are easily changed by various conditions such as vibration, impact, and mechanical modulation. Hence, to achieve reliability and reproducibility of the inspection, a method of easily recognizing positions of the linescan cameras is required and positioning of the linescan cameras must be periodically performed.

### SUMMARY

The following description relates to a vision inspection system which calculates processing parameters of linescan cameras by providing markings on a table on which an inspection object is loaded to be transferred, and an inspection method of inspecting the inspection object using the vision inspection system.

In addition, the following description relates to a vision inspection system which easily performs positioning and arrangement of linescan cameras, and an inspection method of inspecting an inspection object using the vision inspection system.

Also, the following description relates to a vision inspection system which accurately inspects a defect of an inspection object to significantly increase reliability and reproducibility, and an inspection method of inspecting an inspection object using the vision inspection system.

In one general aspect, provided is a vision inspection system including: a work-piece stage configured to include a table on which an inspection object is loaded and move the table between a first position at which the inspection object is loaded and a second position at which an image of the inspection object is scanned; a plurality of linescan cameras, each configured to is be arranged at the second position along a direction orthogonal to a transfer direction of the inspection object and scan an image of the inspection object to obtain a scanned image; and a computer configured to be connected with the work-piece stage and the linescan cameras and process the scanned image of the inspection object which is input from each of the linescan cameras, wherein a plurality of markings, each of which has a marking stage coordinate value, are provided on an upper surface of the table along an arrangement direction of the linescan cameras such that the linescan cameras can obtain scanned images of the markings, each two neighboring markings are placed in a field of view of each of the linescan cameras, the markings between the first and the last markings are respectively placed in overlapping portions of the fields of view of each two neighboring linescan cameras, and the computer is configured to compute marking image coordinate values from scanned images of the markings which are input from the linescan cameras and simultaneously process the scanned image of the inspection object using the marking image coordinate values.

In another general aspect, provided is an inspection method of inspecting an inspection object using a vision inspection system which comprises a work-piece stage configured to include a table on which an inspection object is loaded and move the table linearly between a first position at which the inspection object is loaded and a second position at which an image of the inspection object is scanned, a plurality of linescan cameras, each configured to be arranged at the second position along a direction orthogonal to a transfer direction of the inspection object and scan an image of the inspection object to obtain a scanned image, and a computer configured to be connected with the work-piece stage and the linescan cameras and process the scanned image of the inspection object by processing image data of the inspection object which is input from each of the linescan cameras, the inspection method including: providing a plurality of markings, each of which has a marking stage coordinate value, on an upper surface of the table along an arrangement direction of the linescan cameras such that the linescan cameras can obtain scanned images of the markings; obtaining the scanned images of the markings using the linescan cameras; calculating a marking image coordinate value from the scanned image of each of the markings; obtaining the scanned image of the inspection object using the linescan cameras when the marking image coordinate value falls within an allowable tolerance range with respect to the marking stage coordinate value; calculating a work-piece image coordinate value of the inspection object from the scanned image of the inspection object; calculating a work-piece image-stage coordinate value from the work-piece image coordinate value; and determining the inspection object as being non-defective when the work-piece image-stage coordinate value falls within an allowable tolerance range with respect to the work-piece stage coordinate value.

Other features and aspects will be apparent from the following detailed description, the drawings, and the claims.

### BRIEF DESCRIPTION OF THE DRAWINGS

FIG. 1 is a diagram illustrating a front view of an example of a vision inspection system.

FIG. 2 is a diagram illustrating a side view of an example of a vision inspection system.

FIG. 3 is a diagram illustrating a plan view of an example of a table, markings, and linescan cameras of a vision inspection system.

FIG. 4 is a diagram illustrating a plan view of an inspection object, a table, markings, and linescan cameras of a vision inspection system.

FIG. 5 is a diagram illustrating an example of a scanned image of an inspection object and markings of a vision inspection system.

FIGS. 6 and 7 are flowcharts illustrating an example of an inspection method of inspecting an inspection object.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

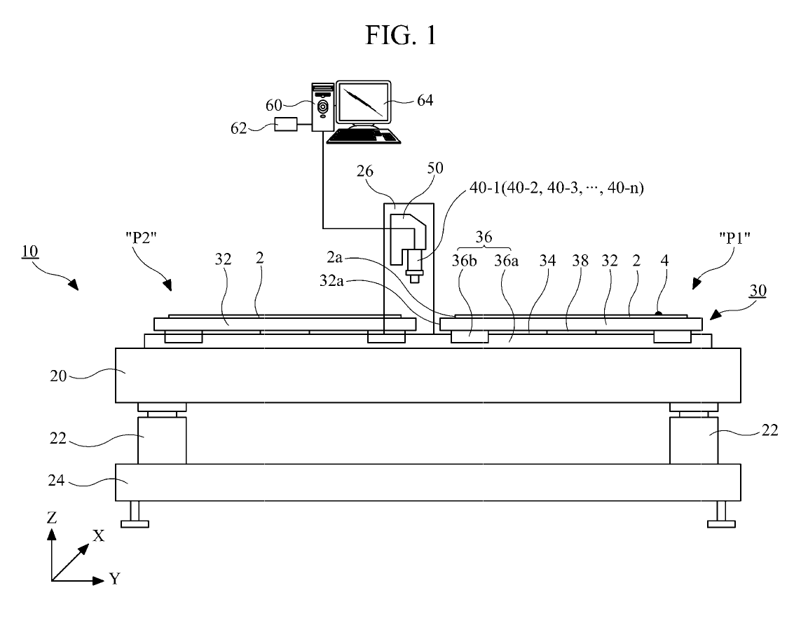

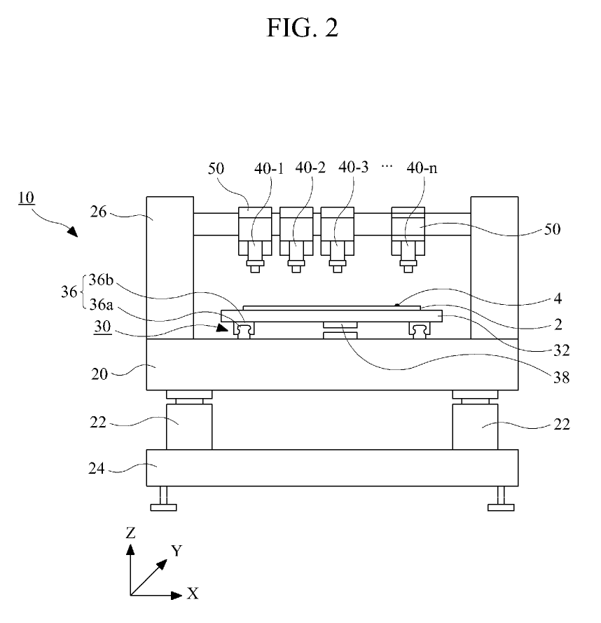

Referring to FIGS. 1 and 2, a vision inspection system 10 inspects and measures a defect 4 of an inspection object 2 which may include a glass substrate, a cell, a module, and the like. The vision inspection system 10 includes a surface table 20 having an upper surface which is completely flat and leveled for precise inspection and measurement of the inspection object 2. Both ends of the upper surface of the surface table 20 have a first position P1 to load and discharge the inspection object 2 and a second position P2 to scan and inspect the inspection object 2. The surface table 20 has an X axis, a Y axis orthogonal to the X axis, and a Z axis perpendicular to the X axis. In addition, the surface table 20 is stably supported by a plurality of base isolators 22 that absorb vibration and impact. The base isolators 22 are mounted on an upper surface of a base 24. An overhead frame 26 is provided on an upper portion of the surface table 20. The overhead frame 26 is disposed on the second position P2 along the X axis in such a manner that is orthogonal to a transfer direction of the inspection object 2.

A work-piece stage 30 is installed on the upper surface of the surface table 20 to load and carry the inspection object 2. The work-piece stage 30 consists of a table 32 and a linear actuator 34. The table 32 is disposed to move on the upper surface of the surface table 20 along one direction of the surface table 20, that is, the X axis or the Y axis. The inspection object 2 is placed fixedly on an upper surface of the table 32 by a clamp or a fixture. In the example shown in FIG. 1, the work-piece stage 30 is configured to move the table 32 from the first position P1 along the Y-axis direction of the surface table 20.

The linear actuator 34 is interposed between the upper surface of the surface table 20 and a lower surface of the table 32. The linear actuator 34 consists of a pair of linear motion guides and a linear motor 38. The pair of linear motion guides is interposed between the upper surface of the surface table 20 and the lower surface of the table 32, and the linear motor is disposed between the pair of linear motion guides and connected to the table 32. The linear motion guides include a pair of guide rails 36a and a plurality of sliders 36b. The guide rails 36a are fixed on the upper surface of the surface table 20, and the sliders 36b are fixed to the lower surface of the table 32 and operable to slide along the guide rails 36a. The table 32 moves linearly by driving of the linear motor 38 and the guide of the linear motion guides 36.

The linear actuator 34 may include a servo motor, a lead screw, a ball nut, and a pair of linear motion guides. The work-piece stage 30 may be implemented as a rectangular coordinate robot having X-axis and Y-axis linear actuators that move the table 32 linearly along the X- and Y-axis directions of the surface table 20. Furthermore, the work-piece stage 30 may include a multiaxial robot that linearly reciprocates the table 32 along the X-, Y-, and Z-axis directions of the surface table 20 and rotates the table 32 with respect to the X, Y, and Z axes. The rectangular coordinate robot or the multiaxial robot enables the inspection object 2 to be positioned precisely on the table 32.

A plurality of linescan cameras 40-1, 40-2, 40-3, . . . , 40-n are arranged on the upper surface of the surface table 20 along the X-axis direction so as to be aligned with respect to the second position P2. The linescan cameras 40-1, 40-2, 40-3, . . . , 40-n divide the inspection object 2 into areas, acquire images of the divided areas, and output scanned images of the inspection object 2. The linescan cameras 40-1, 40-2, 40-3, . . . , 40-n are installed, respectively, on a plurality of camera stages 50. The camera stages 50 are mounted on the overhead frame 26. Because the camera stages 50 are operable to prompt the linescan cameras 40-1, 40-2, 40-3, . . . , 40-n to move linearly in the X-, Y-, or Z-axis directions and to rotate with respect to the X, Y, or Z axis, the positioning and focusing of the linescan cameras 40-1, 40-2, 40-3, . . . , 40-n can be precisely performed. The camera stages 50 may be configured to be driven by the linear actuator, the rectangular coordinate robot, or the multiaxial robot instead of the overhead frame 26.

The vision inspection system 10 shown in the examples illustrated in FIGS. 1 and 2 includes a computer 60 which is connected with the linear motor 38 of the work-piece stage 30 and the linescan cameras 40-1, 40-2, 40-3, . . . , 40-n so as to control the operation of the work-piece stage 30 and the linescan cameras 40-1, 40-2, 40-3, . . . , 40-n. The computer 30 includes a database 62 which stores a series of data for inspecting the inspection object 2 and the defect 4 present on the inspection object 2. The data may include, for example, a size of the inspection object 2, a location value of an inspection area, and an inspection reference value, and be stored in the database as work-piece stage coordinate values.

The computer 60 controls the operation of the work-piece stage 30 to move the inspection object 2 with respect to the linescan cameras 40-1, 40-2, 40-3, . . . , 40-n. Moreover, the computer 60 processes the scanned images input from the linescan cameras 40-1, 40-2, 40-3, . . . , 40-n using an image processing program, and outputs resultant data, such as an output scanned is image of the inspection object 2 and a result of inspecting the defect 4, through an output device such as a monitor 64.

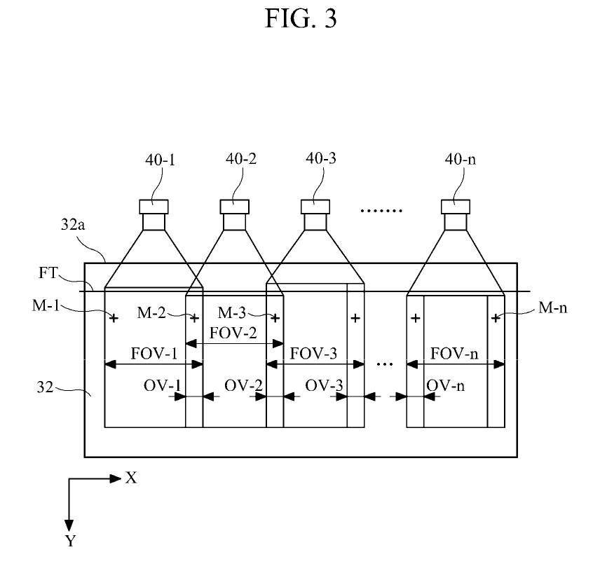

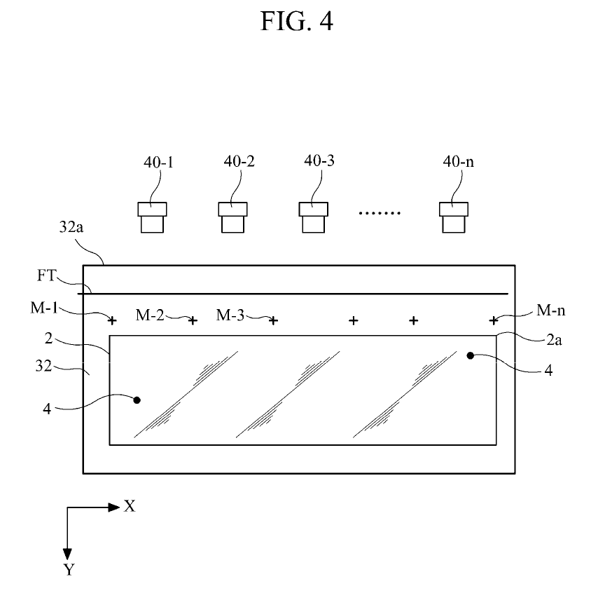

Referring to FIGS. 3 and 4, a plurality of markings M-1, M-2, M-3, . . . , M-n are provided on the upper surface of the table 32 for positioning the linescan cameras 40-1, 40-2, 40-3, . . . , 40-n and processing the scanned image. Each of the markings M-1, M-2, M-3, . . . , M-n has a marking stage coordinate value. The marking stage coordinate values of the markings M-1, M-2, M-3, . . . , M-n are stored in the database 62 of the computer 60. The computer 60 calculates a marking image coordinate value from scanned images of the markings M-1, M-2, M-3, . . . , M-n input from the corresponding linescan cameras 40-1, 40-2, 40-3, . . . , 40-n.

The plurality of markings M-1, M-2, M-3, . . . , M-n are arranged along an arrangement direction of the linescan cameras 40-1, 40-2, 40-3, . . . , 40-n, that is, along the X-axis direction. Every two neighboring markings of all markings M-1, M-2, M-3, . . . , M-n are placed in a field of view FOV-1, FOV-2, FOV-3, . . . , FOV-N of each linescan camera 40-1, 40-2, 40-3, . . . , 40-n. The markings between the first and the last markings M-1 and M-n are respectively placed in overlapping portions of the fields of view of each two neighboring linescan cameras. In the example illustrated in FIG. 3, overlap lengths OV-1, OV-2, OV-3, . . . , OV-n between each two neighboring linescan cameras 40-1, 40-2, 40-3, . . . , 40-n are shown. Although the markings M-1, M-2, M-3, . . . , M-n are cross-shaped, the markings may be of various shapes such as a circle and a rectangle.

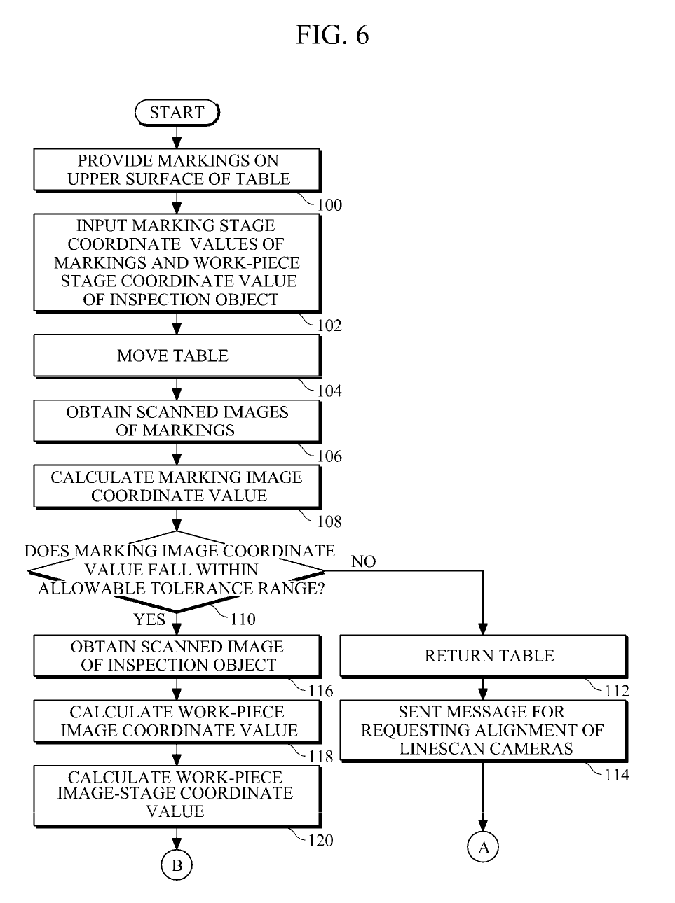

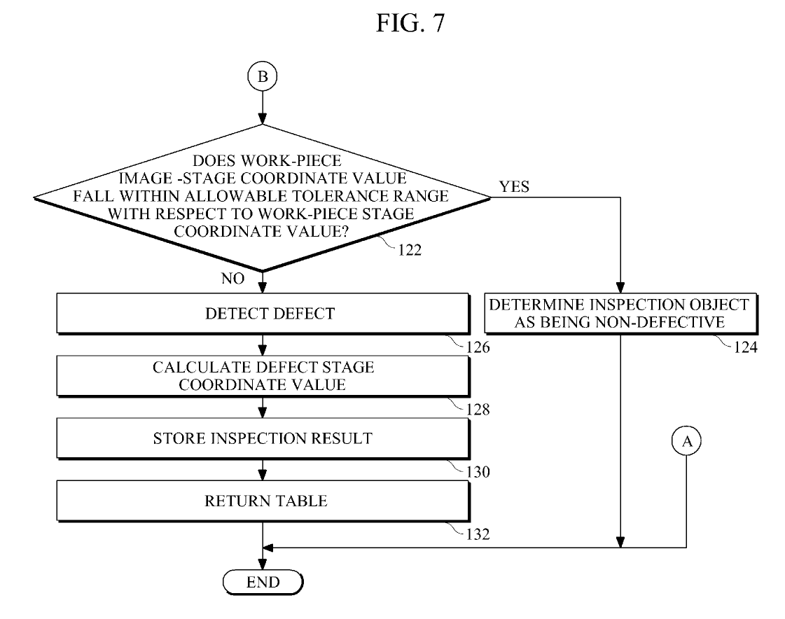

Hereinafter, a method of inspecting an inspection object using the vision inspection system having the above-described configuration will be described with reference to FIGS. 6 and 7.

Referring to FIGS. 6 and 7 in conjunction with FIGS. 1 to 3, a plurality of markings M-1, is M-2, M-3, . . . , M-n, each having a marking stage coordinate value, are provided on the upper surface of the table 32 (S100). The marking stage coordinate values of the markings M-1, M-2, M-3, . . . , M-n and the work-piece stage coordinate value of the inspection object 2 are stored in the database 62 of the computer 60 (S102).

Referring to FIGS. 1, 3, and 4 again, when the inspection object 2 is loaded on the upper surface of the table 32, the table 32 is moved from the first position P1 to the second position P2 by driving the linear actuator 34 (S104). A leading end 2a of the inspection object 2 which is moved while being loaded on the table 32 is located below the markings M-1, M-2, M-3, . . . , M-n. Under the control of the computer 60, the linear motor 38 is driven in one direction, and according to the single-direction motion of the linear motor 38, the table 32 is moved from the first position P1 to the second position P2. The linear motion guides 36 guide the table 32 to move linearly.

Then, the linescan cameras 40-1, 40-2, 40-3, . . . , 40-n are driven to scanned images of the markings M-1, M-2, M-3, . . . , M-n and obtain scanned images (S106), and marking image coordinate values are obtained from the scanned images of the markings M-1, M-2, M-3, . . . , M-n (S108). The computer 60 transmits a frame trigger signal to the linescan cameras 40-1, 40-2, 40-3, . . . , 40-n for the linescan cameras 40-1, 40-2, 40-3, . . . , 40-n to scan the images simultaneously.

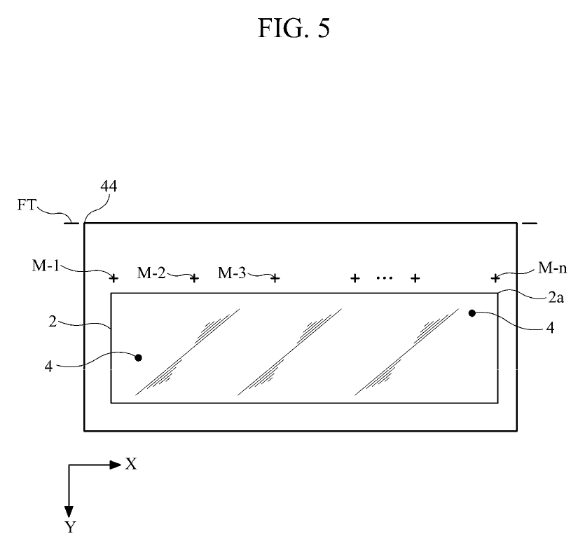

A frame trigger line FT is shown in the examples illustrated in FIGS. 3 to 5. Referring to FIGS. 3 to 5, the frame trigger line FT indicates a time point at which the frame trigger signal is transmitted to the linescan cameras 40-1, 40-2, 40-3, . . . , 40-n from the computer 60 such that the linescan cameras 40-1, 40-2, 40-3, . . . , 40-n can scan the images simultaneously. The frame trigger line FT may be located above the markings M-1, M-2, M-3, . . . , M-n. Once the linescan cameras 40-1, 40-2, 40-3, . . . , 40-n are perfectly aligned, as shown in FIG. 5, scan starting points of the scanned images obtained by the linescan cameras 40-1, 40-2, 40-3, . . . , 40-n, that is, scan starting points in the Y-axis direction, become identical with the frame trigger line FT. The perfect alignment of the linescan cameras 40-1, 40-2, 40-3, . . . , 40-n in which all scan starting points of the linescan cameras 40-1, 40-2, 40-3, . . . , 40-n are identical with the frame trigger line FT is only theoretically possible and is not practical.

The linescan cameras 40-1, 40-2, 40-3, . . . , 40-n input scanned images acquired by capturing images of the moved table 32 and markings M-1, M-2, M-3, . . . , M-n in the computer 60. As illustrated in FIG. 5, the scanned images of the markings M-1, M-2, M-3, . . . , M-n are input to the computer while being included in an image frame 42 obtained by scanning the linescan cameras 40-1, 40-2, 40-3, . . . , 40-n. The computer 60 assigns a zero point at a certain point of the image frame 42, and calculates the marking image coordinate value of the respective markings M-1, M-2, M-3, . . . , M-n with reference to the zero point 44. Although in the example illustrated in FIG. 5, the zero point 44 is located on the left top of the image frame 42, the zero point 44 may be assigned at the bottom left, the top right, or the bottom right according to the circumstances.

Thereafter, the computer 60 determines whether the marking image coordinate values fall within an allowable tolerance range with respect to the marking stage coordinate values of the markings M-1, M-2, M-3, . . . , M-n (S110). The determination of whether the difference between the marking image coordinate values the of the markings M-1, M-2, M-3, . . . , M-n falls within the tolerance error may be performed by verifying processing parameters of the linescan cameras 40-1, 40-2, 40-3, . . . , 40-n. The processing parameters include pixel resolution, an X-axis stage coordinate value OX (mm) and a Y-axis stage coordinate value OY (mm) of the zero point of the image frame, and inclination angles of the linescan cameras. The pixel resolution refers to an actual size of one pixel in the scanned image. The inclination angle of each linescan camera 40-1, 40-2, 40-3, . . . , 40-n refers to an angle of the linescan camera with respect to the X axis. The processing parameters of the linescan cameras 40-1, 40-2, 40-3, . . . , 40-n are acquired from the marking stage coordinate values and the marking image coordinate values.

An actual size value ReX (mm/Px) of one pixel in the X-axis direction with respect to the scanned images of the markings M-1, M-2, M-3, . . . , M-n is calculated using Equation 1. Although Rex is determined by optical systems of the linescan cameras 40-1, 40-2, 40-3, . . . , 40-n there may be a minute error due to alignment errors between the linescan cameras 40-1, 40-2, 40-3, . . . , 40-n. Thus, for precise inspection of the inspection object 2, Rex is calculated using Equation 1 below

$$Re X = \frac{( {M}_{2} X - {M}_{1} X )}{( {m}_{2} x - {m}_{1} x )} , \qquad ( 1 )$$

where X and x have the same positive direction. M₁X represents an X-axis stage coordinate value of the left marking of the two markings which are located in each field of vision of the linescan cameras. M₂X represents an X-axis stage coordinate value of the right marking m₁x represents an X-axis image coordinate value of the left marking. m₂x represents an X-axis image coordinate value of the right marking.

The inclination angle θ (radian) of each linescan camera with respect to the X axis is obtained using Equation 2 as below

$$θ = {tan}^{- 1} \frac{{M}_{2} Y - {M}_{1} Y}{{M}_{2} X - {M}_{1} X} - {tan}^{- 1} \frac{( {m}_{2} y - {m}_{1} y )}{( {m}_{2} x - {m}_{1} x )} , \qquad ( 2 )$$

where M₂Y represents a Y-axis stage coordinate value of the right marking of the two markings placed in the field of view of each linescan camera. m₂y indicates a Y-axis image coordinate value of the right marking.

The X-axis stage coordinate value OX (mm) and Y-axis stage coordinate value OY (mm) of the zero point 44 of the image frame 42 can be obtained as defined by Equations 3 below. OX and OY represent the actual coordinate values on the table.

OX=M₁X−m₁x×ReX

OY=M₁Y−m₁y×ReY−m₁x×ReX×tan θ (3)

Here, X and x have the same positive direction, and Y and y also have the same positive direction. M₁Y represents a Y-axis stage coordinate value of the left marking of the two markings placed in the field of view of each linescan camera. m₁y represents a Y-axis image coordinate value of the left marking.

An actual size ReY (mm/Px) of one pixel in the Y-axis direction with respect to the scanned images of the markings M-1, M-2, M-3, . . . , M-n is determined by a travel speed S (mm/sec) of the inspection object and a cycle C (sec) of the trigger signal, and can be calculated as defined by Equation 4:

ReY=S×C (4)

To inspect a scanned image of the inspection object 2, the processing parameters of the linescan cameras 40-1, 40-2, 40-3, . . . , 40-n should be accurate. If the processing parameters are out of an allowable tolerance range, the precise inspection of the inspection object 2 cannot be realized. If the processing parameters of the linescan cameras 40-1, 40-2, 40-3, . . . , 40-n, which are obtained by processing the marking stage coordinate values and the marking image coordinate values, are within the allowable tolerance range, the computer 60 determines that the arrangement of the linescan cameras 40-1, 40-2, 40-3, . . . , 40-n is completed.

If the marking image coordinate values are out of the allowable tolerance range, the computer 60 stops the linescan cameras 40-1, 40-2, 40-3, . . . , 40-n, and drives the linear motor 38 is of the linear actuator 34 in another direction to return the table 32 to the first position P1 (S112). When the table 32 is returned to the first position P1, the computer 60 outputs a message to request the arrangement of the linescan cameras 40-1, 40-2, 40-3, . . . , 40-n to an output device such as a monitor 62 (S114), and is terminated. An operator operates the camera stages 50 of the respective linescan cameras 40-1, 40-2, 40-3, . . . , 40-n to enable the linescan cameras 40-1, 40-2, 40-3, . . . , 40-n to move linearly in the X-, Y-, and Z-axis directions and rotate with respect to the X, Y, and Z axes. Accordingly, precise positioning and focusing of the linescan cameras 40-1, 40-2, 40-3, . . . , 40-n can be performed, thereby aligning the linescan cameras 40-1, 40-2, 40-3, . . . , 40-n.

Meanwhile, in operation S110, when the marking image coordinate values are within the allowable tolerance range, the computer 60 drives the linescan cameras 40-1, 40-2, 40-3, . . . , 40-n to scan the inspection object 2 to obtain the scanned image (S116). The linescan cameras 40-1, 40-2, 40-3, . . . , 40-n scan the inspection object 2 which is moved while being loaded on the table 32 to obtain the scanned image, and input the scanned image of the inspection object 2 to the computer 60.

The computer 60 calculates the work-piece image coordinate value from the scanned image of the inspection object 2 (S118), and calculates a work-piece image-stage coordinate value from the calculated work-piece image coordinate value (S120). The computer 60 substitutes the work-piece image coordinate value in the stage coordinate transformation to produce the work-piece image-stage coordinate value. The work-piece image-stage coordinate value is an actual stage coordinate value of the inspection object 2.

The stage coordinate transformation may be expressed as Equations 5, which calculates the work-piece stage coordinate value from the work-piece image coordinate value.

WX=OX+wx×ReX

WY=OY+wy×ReY+wx×ReX×tan θ (5)

Here, WX (mm) represents a work-piece stage coordinate value with respect to the X axis, and WY (mm) represents a work-piece stage coordinate value with respect to the Y axis. wx represents a work-piece image coordinate value with respect to the X axis, and wy represents a work-piece image coordinate value with respect to the Y axis.

The computer 60 determines whether the work-piece image-stage coordinate value obtained from Equation 5 falls within an allowable tolerance range with respect to the work-piece stage coordinate value (S122). When the work-piece image-stage coordinate value is within the allowable tolerance range with respect to the work-piece stage coordinate value, the computer 60 determines that the inspection object 2 is non-defective (S124).

When the work-piece image-stage coordinate value is out of the allowable tolerance range with respect to the work-piece stage coordinate value, the computer 60 detects a difference between the work-piece image-stage coordinate value and the allowable tolerance range with respect to the work-piece stage coordinate value as a defect 4 (S126), and calculates a defect stage coordinate value of the defect 4 (S128). Specifically, the computer 60 computes a defect image coordinate value of the defect 4 from the scanned image of the inspection object 2, and calculates the defect stage coordinate value of the defect 4 by substituting the defect image coordinate value in the stage coordinate transformation in the same manner as when producing the work-piece image-stage coordinate value. The defect stage coordinate value is an actual coordinate value of the defect 4 which is present on the inspection object 2.

Referring to FIGS. 3 to 5 again, various types of defects 4 such as impurities, stones, codes, cracks, projections, and pits may be present on the inspection object 2, for example, a is glass substrate for a TFT-LCD. Such a defect 4 is included in the scanned image of the glass substrate as the result of scanning the linescan cameras 40-1, 40-2, 40-3, . . . , 40-n. The glass substrate is determined as being defective based on the image of the defect 4 included in the scanned image.

A TFT-LCD panel has a sealed liquid crystal inlet. To inspect location and break of the seal, a stage coordinate value of the seal, that is, a target value of the seal, is first acquired, and then input to the database of the computer 60. Then, an image coordinate value and an image-stage coordinate value are obtained from the scanned image of each linescan camera 40-1, 40-2, 40-3, . . . , 40-n. If the seal is broken, the image-stage coordinate value falls out of the allowable tolerance range with respect to the stage coordinate value, and accordingly, the TFT-LCD panel is determined as being defective. The computer 60 determines a region where the seal is broken as a defect. In addition, if the length of the seal that is calculated from the scanned image of the seal is greater than the allowable tolerance range, the seal is determined as a defect.

The computer 60 displays the result of inspecting the inspection object 2 through an output device such as the monitor 62, and stores the result in the database 64 (S130). The computer 60 calculates a size of the defect 4, and determines the inspection object 2 that has the defect 4 as being defective. Finally, once the inspection of the inspection object 2 is completed, the table 32 is returned from the second position P2 to the first position P1 (S132). Thus, the defect 4 of the inspection object 2 can be precisely inspected, thereby significantly increasing the reliability and reproducibility.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or is supplemented by other components or their equivalents. Accordingly, other implementations are within the scope of the following claims.

As described above, according to the vision inspection system and the inspection method of inspecting an inspection object using the vision inspection system, a plurality of markings are provided as references on a table which is moved while loading the inspection object thereon, processing parameters of linescan cameras are calculated with reference to the markings, and positioning and aligning of the linescan cameras are conveniently performed by verifying the processing parameters. Moreover, a defect of the inspection object is precisely and accurately inspected, so that the reliability and reproducibility can be substantially improved.

What is claimed is:

1. A vision inspection system comprising:
a work-piece stage configured to include a table on which an inspection object is loaded and move the table between a first position at which the inspection object is loaded and a second position at which an image of the inspection object is scanned;
a plurality of linescan cameras, each configured to be arranged at the second position along a direction orthogonal to a transfer direction of the inspection object and scan an image of the inspection object to obtain a scanned image; and
a computer configured to be connected with the work-piece stage and the linescan cameras and process the scanned image of the inspection object which is input from each of the linescan cameras,
wherein a plurality of markings, each of which has a marking stage coordinate value, are provided on an upper surface of the table along an arrangement direction of the linescan cameras such that the linescan cameras can obtain scanned images of the markings, each two neighboring markings are placed in a field of view of each of the linescan cameras, the markings between the first and the last markings are respectively placed in overlapping portions of the fields of view of each two neighboring linescan cameras, and the computer is configured to compute marking image coordinate values from scanned images of the markings which are input from the linescan cameras and simultaneously process the scanned image of the inspection object using the marking image coordinate values.

2. The vision inspection system of claim 1, wherein the computer is configured to process the scanned image of the inspection object when the marking image coordinate value falls within an allowable tolerance range with respect to the marking stage coordinate value.

3. The vision inspection system of claim 2, wherein the inspection object includes one or more defects of which scanned images can be obtained by scanning the linescan cameras, and the computer is configured to process the scanned images of the defects to calculate a defect stage coordinate value based on the marking stage coordinate value.

4. The vision inspection system of claim 1, wherein the table is moved along a Y-axis direction, the linescan cameras and the markings are arranged along an X-axis direction orthogonal to the Y-axis direction, the computer is configured to achieve an actual size of one pixel ReX (mm/Px) in the X-axis direction with respect to the scanned images of the markings using
$$Re X = \frac{( {M}_{2} X - {M}_{1} X )}{( {m}_{2} x - {m}_{1} x )} ,$$
where X and x have the same positive direction, M₁X represents an X-axis stage coordinate value of the left marking of the two markings which are located in each field of vision of the linescan cameras, M₂X represents an X-axis stage coordinate value of the right marking, m₁x represents an X-axis image coordinate value of the left marking and m₂x represents an X-axis image coordinate value of the right marking.

5. The vision inspection system of claim 4, wherein the computer is configured to achieve an inclination angle θ (radian) of each of the linescan cameras with respect to a X axis using
$$θ = {tan}^{- 1} \frac{{M}_{2} Y - {M}_{1} Y}{{M}_{2} X - {M}_{1} X} - {tan}^{- 1} \frac{( {m}_{2} y - {m}_{1} y )}{( {m}_{2} x - {m}_{1} x )} ,$$
where M₂Y represents a Y-axis stage coordinate value of the right marking of the two markings placed in the field of view of each linescan camera, and m₂y indicates a Y-axis image coordinate value of the right marking.

6. The vision inspection system of claim 5, wherein the computer is configured to include the scanned images of the markings in an image frame obtained by scanning the linescan cameras, assign a zero point to the image frame, and obtain an X-axis stage coordinate value OX (mm) and a Y-axis stage coordinate value OY (mm) of the zero point using
OX=M₁X−m₁x×ReX
OY=M₁Y−m₁y×ReY−m₁x×ReX×tan θ,
where X and x have the same positive direction, Y and y also have the same positive direction, M₁Y represents a Y-axis stage coordinate value of the left marking of the two markings which are placed in the field of view of each linescan camera, and m₁y represents a Y-axis image coordinate value of the left marking.

7. The vision inspection system of claim 6, wherein the computer is configured to obtain a work-piece coordinate value WX (mm) with respect to the X axis and a work-piece coordinate value WY (mm) with respect to the Y axis using
WX=OX+wx×ReX
WY=OY+wy×ReY+wx×ReX×tan θ,
where WX (mm) represents a work-piece stage coordinate value with respect to the X axis, and WY (mm) represents a work-piece stage coordinate value with respect to the Y axis, wx represents a work-piece image coordinate value with respect to the X axis, and wy represents a work-piece image coordinate value with respect to the Y axis.

8. An inspection method of inspecting an inspection object using a vision inspection system which comprises a work-piece stage configured to include a table on which an inspection object is loaded and move the table linearly between a first position at which the inspection object is loaded and a second position at which an image of the inspection object is scanned, a plurality of linescan cameras, each configured to be arranged at the second position along a direction orthogonal to a transfer direction of the inspection object and scan an image of the inspection object to obtain a scanned image, and a computer configured to be connected with the work-piece stage and the linescan cameras and process the scanned image of the inspection object by processing image data of the inspection object which is input from each of the linescan cameras, the inspection method comprising:
providing a plurality of markings, each of which has a marking stage coordinate value, on an upper surface of the table along an arrangement direction of the linescan cameras such that the linescan cameras can obtain scanned images of the markings;
obtaining the scanned images of the markings using the linescan cameras;
calculating a marking image coordinate value from the scanned image of each of the markings;
obtaining the scanned image of the inspection object using the linescan cameras when the marking image coordinate value falls within an allowable tolerance range with respect to the marking stage coordinate value;
calculating a work-piece image coordinate value of the inspection object from the scanned image of the inspection object;
calculating a work-piece image-stage coordinate value from the work-piece image coordinate value; and
determining the inspection object as being non-defective when the work-piece image-stage coordinate value falls within an allowable tolerance range with respect to the work-piece stage coordinate value.

9. The inspection method of claim 8, wherein the providing of the plurality of markings includes placing each neighboring two markings in a field of view of each of the linescan cameras and placing the respective markings between the first and the last markings in overlapping portions of the fields of view of each two neighboring linescan cameras.

10. The inspection method of claim 9, wherein the providing of the plurality of markings includes placing a frame trigger line above the marking, wherein at the frame trigger line, a frame trigger signal is transmitted from the computer to each of the linescan cameras, and placing a leading end of the inspection object below the markings.

11. The inspection method of claim 8, wherein the determination of whether the marking image coordinate value falls within the allowable tolerance range is performed by calculating processing parameters of the linescan cameras from the marking stage coordinate value and the marking image coordinate value and verifying the processing parameters.

12. The inspection method of claim 11, further comprising:
returning the table to the second position when the marking image coordinate value falls out of the allowable tolerance range.

13. The inspection method of claim 11, wherein the calculating of the work-piece image-stage coordinate value includes yielding stage coordinate transformation, which transforms the marking image coordinate value into the marking stage coordinate value, from a relation between the marking stage coordinate value and the marking image coordinate value and substituting the work-piece image coordinate value in the stage coordinate transformation to produce the work-piece image-stage coordinate value.

14. The inspection method of claim 8, further comprising:
when the work-piece image-stage coordinate value falls out of the allowable tolerance range, detecting a difference between the work-piece image-stage coordinate value and the allowable tolerance range with respect to the work-piece stage coordinate value as a defect; and
calculating a defect stage coordinate value of the defect.

15. The inspection method of claim 14, wherein the calculating of the defect stage coordinate value includes yielding stage coordinate transformation, which allows the marking image coordinate value to be transformed into the marking stage coordinate value, from a relation between the marking stage coordinate value and the marking image coordinate value and substituting the defect image coordinate value in the stage coordinate transformation to produce the defect stage coordinate value.

16. The inspection method of claim 8, wherein the table is moved along a Y-axis direction, the linescan cameras and the markings are arranged along an X-axis direction orthogonal to the Y-axis direction, and the computer is configured to achieve an actual size of
$$Re X = \frac{( {M}_{2} X - {M}_{1} X )}{( {m}_{2} x - {m}_{1} x )} ,$$
where X and x have the same positive direction, M₁X represents an X-axis stage coordinate value of the left marking of the two markings which are located in each field of vision of the linescan cameras, M₂X represents an X-axis stage coordinate value of the right marking, m₁x represents an X-axis image coordinate value of the left marking and m₂x represents an X-axis image coordinate value of the right marking.

17. The inspection method of claim 16, wherein the computer achieves an inclination angle θ (radian) of each of the linescan cameras with respect to a X axis using
$$θ = {tan}^{- 1} \frac{{M}_{2} Y - {M}_{1} Y}{{M}_{2} X - {M}_{1} X} - {tan}^{- 1} \frac{( {m}_{2} y - {m}_{1} y )}{( {m}_{2} x - {m}_{1} x )} ,$$
where M₂Y represents a Y-axis stage coordinate value of the right marking of the two markings placed in the field of view of each linescan camera, and m₂y indicates a Y-axis image coordinate value of the right marking.

18. The inspection method of claim 17, wherein the computer includes the scanned images of the markings in an image frame obtained by scanning the linescan cameras, assigns a zero point to the image frame, and obtains an X-axis stage coordinate value OX (mm) and a Y-axis stage coordinate value OY (mm) of the zero point using
OX=M₁X−m₁x×ReX
OY=M₁Y−m₁y×ReY−m₁x×ReX×tan θ,
where X and x have the same positive direction, Y and y also have the same positive direction, M₁Y represents a Y-axis stage coordinate value of the left marking of the two markings which are placed in the field of view of each linescan camera, and m₁y represents a Y-axis image coordinate value of the left marking.

19. The inspection method of claim 18, wherein the computer obtains a work-piece coordinate value WX (mm) with respect to the X axis and a work-piece coordinate value WY (mm) with respect to the Y axis using
WX=OX+wx×ReX
WY=OY+wy×ReY+wx×ReX×tan θ,
where WX (mm) represents a work-piece stage coordinate value with respect to the X axis, and WY (mm) represents a work-piece stage coordinate value with respect to the Y axis, wx represents a work-piece image coordinate value with respect to the X axis, and wy represents a work-piece image coordinate value with respect to the Y axis.
